(19) United States
(12) Patent Application Publication
(10) Pub. No.: US 2026/0239161 A1
(43) Pub. Date: Aug. 13, 2026

(54) SUPPORT FOR VPLMN URSP RULES

(71) Applicant: InterDigital Patent Holdings, Inc., Wilmington, DE (US)

(72) Inventors: Zhibi Wang, Woodridge, IL (US); Michael Starsinic, Newtown, PA (US); Michel Roy, Candiac (CA); Taimoor Abbas, Sainte-Julie (CA)

(73) Assignee: InterDigital Patent Holdings, Inc., Wilmington, DE (US)

(21) Appl. No.: 19/469,824

(22) PCT Filed: Apr. 5, 2024
(86) PCT No.: PCT/US2024/023233

§ 371 Date: Sep. 26, 2025

Related U.S. Application Data
(60) Provisional application No. 63/457,549, filed on Apr. 6, 2023.

(51) Int. Cl. H04W 40/20; H04W 8/02; H04W 84/04; H04W 88/06

(52) U.S. Cl. CPC H04W 40/20; H04W 8/02; H04W 84/042; H04W 88/06

(57) ABSTRACT

A PCF determines a WTRU is not configured to support VPLMN route selection policy rules. The PCF receives a first message that comprises service parameters associated with the WTRU. The service parameters may be used to generate VPLMN route selection policy rules which apply if the WTRU is registered in a VPLMN. If the PCF has determined that the WTRU does not support VPLMN route selection policy rules, the PCF sends a second message indicating that the VPLMN route selection policy rules will be sent to the WTRU if the WTRU becomes registered in the VPLMN. The PCF receives a third message from a network function. If the third message indicates the WTRU is registered in the VPLMN, the PCF sends a fourth message to the WTRU. The fourth message comprises generated VPLMN route selection policy rules for use by the WTRU in the VPLMN.

### CROSS-REFERENCE TO RELATED APPLICATIONS

This application claims the benefit of U.S. Provisional Application No. 63/457,549, filed Apr. 6, 2023, the contents of which are incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are disclosed for supporting visited public land mobile network (VPLMN) specific rule features.

A computing system, which may comprise, for example, a policy control function (PCF), may determine a wireless transmit and receive unit (WTRU) is not configured to support VPLMN route selection policy rules. The computing system may receive a first message that comprises service parameters associated with the WTRU. The service parameters may be used to generate VPLMN route selection policy rules for the WTRU wherein the rules apply if the WTRU is registered in a first VPLMN. The first message may be received, for example, from a user data repository (UDR).

On a condition that the computing system has determined that the WTRU is not configured to support VPLMN route selection policy rules, the computing system may send a second message. The second message may indicate that the VPLMN route selection policy rules are to be sent to the WTRU if the WTRU becomes registered in the first VPLMN.

The computing system may receive a third message from a network function. The third message may indicate that the WTRU has become registered in the first VPLMN. The computing system may generate VPLMN route selection policy rules using the received service parameters associated with the WTRU.

On a condition that the third message indicates the WTRU is registered in the first VPLMN, the computing system may send a fourth message to the WTRU. The fourth message may comprise the generated VPLMN route selection policy rules for the WTRU while in the first VPLMN.

In examples, the computing system may receive a first message from an access and mobility management function (AMF). The first message may comprise an indication that a wireless transmit and receive unit (WTRU) is not configured to support a visited public land mobile network (VPLMN) specific route selection policy rule feature. The first message may comprise a policy classmark information element indicating the WTRU is not configured to support the VPLMN rule feature.

The computing system may receive a second message from a second PCF, which may be a V-PCF. The received second message may comprise service parameters. The computing system may determine that the service parameters are associated with the WTRU.

In response to the second message, the computing system may send a third message to the second PCF. The third message may indicate that the service parameters are to be used to generate route selection policy rules for the WTRU and that the route selection policy rules are to be sent to the WTRU if the WTRU is registered in the VPLMN.

The computing system may send a subscription request to a network function which may be, for example, an AMF. The subscription request may indicate a request to receive a notification if the WTRU is registered in a public land mobile network (PLMN) associated with the service parameters. The computing system may receive a notification message from the network function. The notification message may indicate that the WTRU is registered in the PLMN.

The computing system may then send a fourth message directed to the WTRU. The fourth message may comprise at least one VPLMN specific route selection policy rule constructed based on the service parameters. The fourth message may not comprise an information element indicating an association between PLMNs and UPSIs.

In examples, a WTRU may be configured to support the VPLMN rule feature. The computing system may receive a first message comprising an indication that the WTRU is configured to support the VPLMN specific route selection policy rule feature.

The computing system may receive from the second PCF a second message comprising service parameters. The computing system may determine that the service parameters are associated with the WTRU.

In response to the second message, the WTRU may send a third message indicating that the service parameters are to be used to generate route selection policy rules for the WTRU and that the route selection policy rules are to be sent to the WTRU. The third message may indicate that the route selection policy rules are to be sent to the WTRU immediately or may indicate that the rules are to be sent to the WTRU upon the WTRU being in the CM-CONNECTED state.

The WTRU may then send a fourth message directed to the WTRU. The fourth message may comprise at least one VPLMN specific route selection policy rule constructed based on the service parameters. The fourth message may be sent in response to the second message.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a system in which various aspects and examples may be implemented.

FIG. 3 depicts an example implementation for determining URSP support indication.

### DETAILED DESCRIPTION

A more detailed understanding may be had from the following description, given by way of example in conjunction with the accompanying drawings.

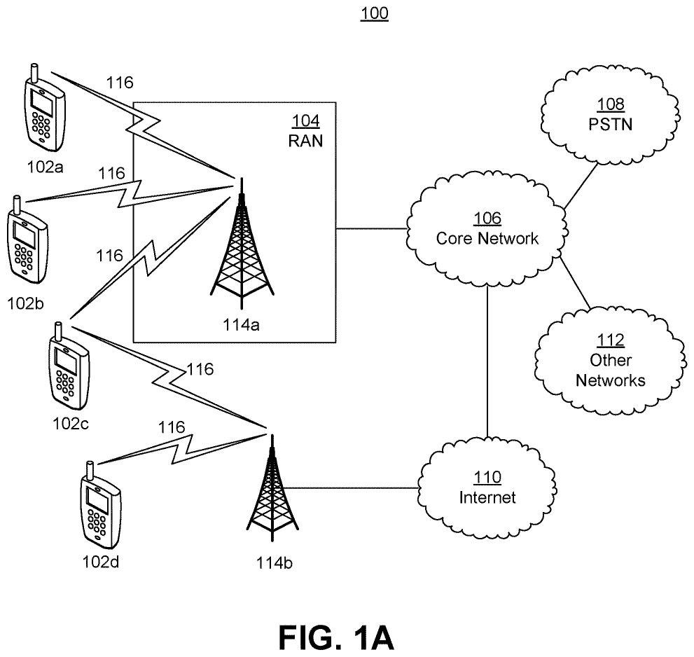

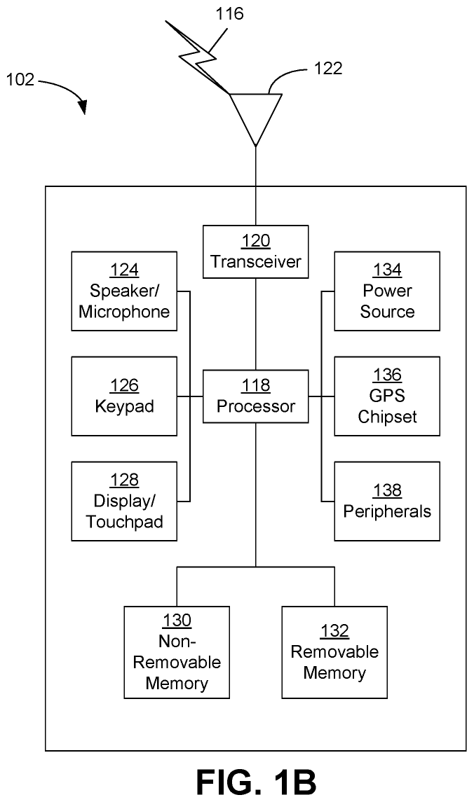

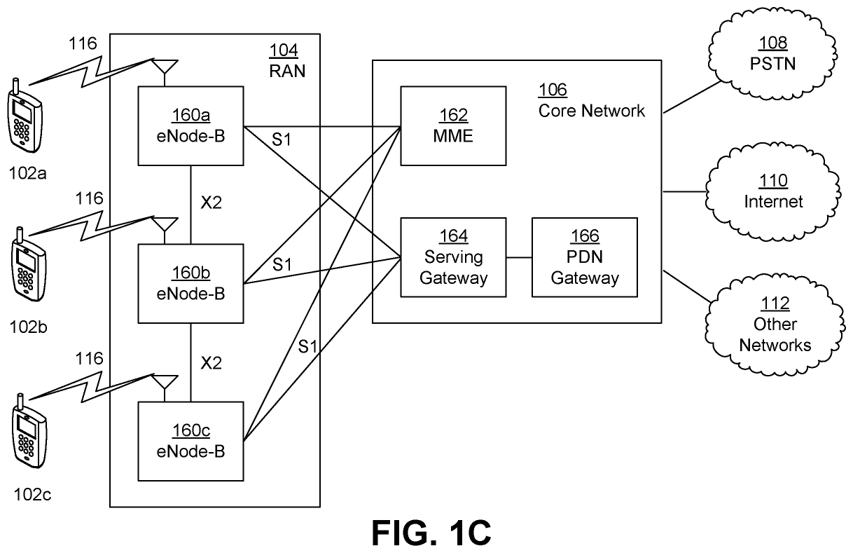

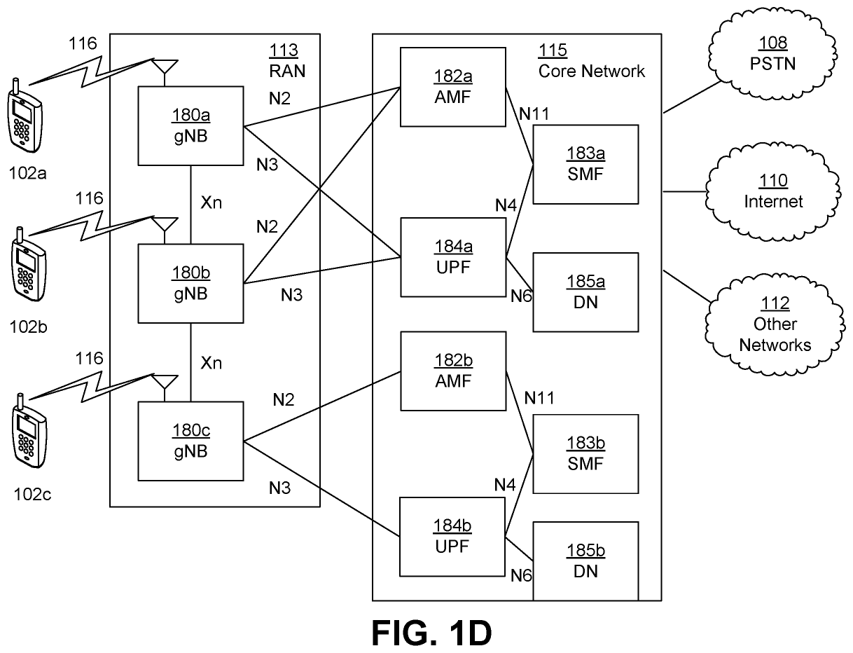

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WIMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102 d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUS 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

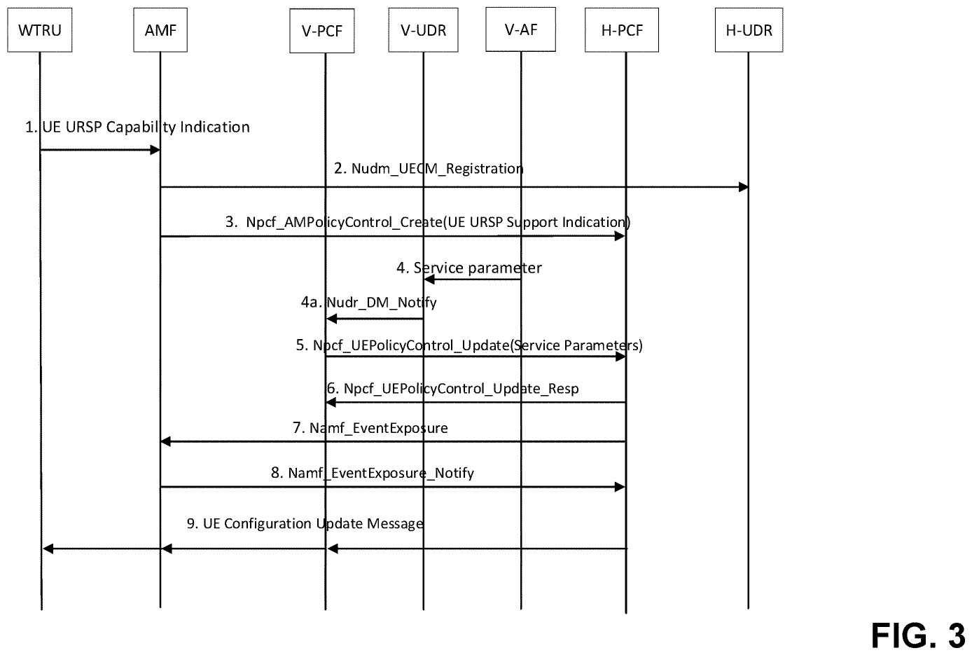

The aspects described and contemplated in this application may be implemented in many different forms. FIG. 3 described herein may provide some examples, but other examples are contemplated. The discussion of FIG. 3 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined.

Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various numeric values are used in examples describing the present application for purposes of describing examples and the aspects described are not limited to these specific values.

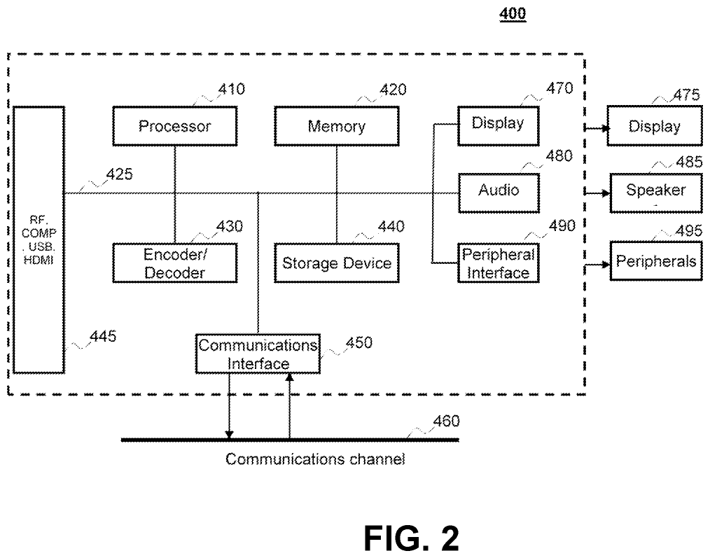

FIG. 2 is a diagram showing an example of a system in which various aspects and examples described herein may be implemented. System 400 may be embodied as a device including the various components described herein and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 may include embedded memory, input output interface, and various other circuitries as known in the art. The system 400 includes at least one memory 420 (e.g., a volatile memory device, and/or a non-volatile memory device). System 400 includes a storage device 440, which may include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 may include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 may include its own processor and memory. The encoder/decoder module 430 represents module(s) that may be included in a device to perform the encoding and/or decoding functions. As is known, a device may include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 may store one or more of various items during the performance of the processes described in this document. Such stored items may include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High-Definition Multimedia Interface (HDMI) input terminal. Other examples, not shown in FIG. 2, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

Additionally, the USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the data stream as necessary for presentation on an output device.

Various elements of system 400 may be provided within an integrated housing. Within the integrated housing, the various elements may be interconnected and transmit data therebetween using suitable connection arrangement 425, for example, an internal bus as known in the art, including the Inter-IC (I2C) bus, wiring, and printed circuit boards.

The system 400 includes communication interface 450 that enables communication with other devices via communication channel 460. The communication interface 450 may include, but is not limited to, a transceiver configured to transmit and to receive data over communication channel 460. The communication interface 450 may include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 may provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 may also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV. Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 may alternatively be separated from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Note that syntax elements as used herein, for example, coding syntax on latent vectors, attention values, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. Encoder signals may include, for example, an indication of motion flow data, an indication of quantized motion flow data, etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g., using a monitor, screen, or other type of display) a resulting image (e.g., an image from residual reconstruction of the video bitstream). The TV, set-top box, cell phone, tablet, or other electronic device may receive a signal including an encoded image and perform decoding.

Systems, methods, and instrumentalities are disclosed herein for supporting visited public land mobile network (VPLMN) specific rule features. Implementations are disclosed whereby a PCF (Policy Control Function) may determine if a WTRU supports the VPLMN specific URSP (UE Route Selection Policy) rules feature. The PCF may use this information to determine when to update a non-supporting WTRU with VPLMN specific URSP rules. The PCF may determine the WTRU's support for the VPLMN specific rule feature and may configure a NWDAF (network data analytics function) to monitor how the WTRU applies URSP rules. If the WTRU does not support the VPLMN specific rule feature, the PCF may subscribe to the AMF to receive notifications of the WTRU's registered PLMN ID so that it knows when to update the WTRU. If the WTRU does support the VPLMN specific rule feature, the PCF may immediately update or re-configure the WTRU.

A WTRU may either support or not support a URSP release. In examples, a first PCF may be a Home PCF (H-PCF) wherein the PCF may be in a network that is considered to be the home network of a WTRU. A second PCF may be a Visited PCF (V-PCF) wherein the second PCF may be in a network that is considered to be a visited network of a WTRU.

The first PCF may receive a first message that indicates if a WTRU supports the VPLMN specific rule feature. The first message may be received, for example, from an AMF or a UDR. The first message may be, for example, a UE STATE INDICATION message that may be received from a WTRU via the AMF. The UE STATE INDICATION message may include, for example, a UE policy classmark information element that may indicate if the WTRU supports the VPLMN specific rule feature.

The first PCF may receive a second message from a second PCF. The second message may include, for example, service parameters. The first PCF may determine that the service parameters are associated with the WTRU.

The first PCF may send a first response message to the second message received from the second PCF. On the condition that the first message indicates that the WTRU does not support the VPLMN specific rule feature, the first response message may indicate that the service parameters may not be used to generate URSP rules for the WTRU. On the condition that the first message indicates that the WTRU does not support the VPLMN specific rule feature, the first response message may indicate that the service parameters may be used to generate URSP rules for the WTRU, and that the WTRU may be sent, e.g., only be sent, the URSP rules if the WTRU is registered in the VPLMN.

On the condition that the first message indicates that the WTRU does support the VPLMN specific rule feature, the first response message may indicate that the service parameters will be used to generate URSP rules for the WTRU, and that the URSP rules will be sent to the WTRU immediately or the next time the WTRU is in the CM-CONNECTED state.

The first response message may be a notification that indicates that the policies were delivered to the WTRU, and the notification may also indicate whether the WTRU indicated support for reception of VPLMN specific URSP rules.

On the condition that the first message indicates that the WTRU does not support the VPLMN specific rule feature, the first PCF may send a subscription request to a network function to receive a notification if the WRTU is registered in the PLMN that is associated with the service parameters and receives a notification from the network function that the WTRU is registered in the PLMN. The network function may be, for example, an AMF.

The first PCF may send a third message to the WTRU. The third message may include the VPLMN specific rules which may have been constructed based on the service parameters. On the condition that the first message indicates that the WTRU does not support the VPLMN specific rule feature, the PCF may trigger sending the message to the WTRU based on receiving the notification that the WTRU is registered in the PLMN. On the condition that the first message indicates that the WTRU does not support the VPLMN specific rule feature, the third message may not include an information element that indicates an association between PLMN(s) and UPSI(s).

On the condition that the first message indicates that the WTRU does support the VPLMN specific rule feature, the PCF may trigger sending the message to the WTRU based on receiving the second message. On the condition that the first message indicates that the WTRU does support the VPLMN specific rule feature, the third message may include an information element that indicates an association between PLMN(s) and UPSI(s).

UE Route Selection Policy (URSP) rules may describe the relationship between traffic flows and corresponding routing. If traffic is initiated by a WTRU Application, the WTRU may use URSP rules to determine the desired characteristics for the PDU Session that may carry the application traffic. An example of characteristics of a PDU Session are the DNN, S-NSSAI, and SSC Mode that is associated with the PDU Session.

The URSP rule may be a policy that may be used by the WTRU to determine how to route outgoing traffic. Traffic may be routed to an established PDU Session, may be offloaded to non-3GPP access outside a PDU Session, may be routed via a ProSe Layer-3 UE-to-Network Relay outside a PDU session, or may trigger the establishment of a new PDU Session.

Each URSP rule may consist of two parts. The first part of the URSP rule may be a Traffic descriptor that may be used to determine when the rule is applicable. A URSP rule may be determined to be applicable if every component in the Traffic descriptor matches the corresponding information from the application. The second part of the URSP rule may be a list of Route Selection Descriptors (RSD). The list of Route Selection Descriptors may contain one or more Route Selection Descriptors. The RSDs may be listed in priority order and may describe the characteristics of a PDU Session that may be used to carry the uplink application data. Characteristics of a PDU Session include SSC Mode, DNN, and S-NSSAI. The RSD may alternatively include a Non-Seamless Offload indication that may indicate that the traffic may be sent via non-3GPP access (e.g., Wi-Fi) and outside of any PDU Session.

For every newly detected application, the WTRU may evaluate the URSP rules in the order of Rule Precedence and determine if the application matches the traffic descriptor of any URSP rule. If a URSP rule is determined to be applicable for a given application, the WTRU may select a Route Selection Descriptor within this URSP rule in the order of the Route Selection Descriptor Precedence.

If a valid Route Selection Descriptor is found, the WTRU may determine if there is an existing PDU Session that matches all components in the selected Route Selection Descriptor. If a matching PDU Session exists, the WTRU may associate the application to the existing PDU Session, e.g., the WTRU may route the traffic of the detected application on this PDU Session. If none of the existing PDU Sessions matches the RSD, the WTRU may try to establish a new PDU Session using the values specified by the selected Route Selection Descriptor.

If the RSD includes a Non-Seamless Offload indication, the WTRU may attempt to use a WLAN (Wireless Local Area Network) access network to transmit the data outside of a PDU Session. WLANSP (WLAN Selection Policy) rules may have been used to select the WLAN Access network.

Once traffic from an application is associated with a PDU Session, an event may cause the WTRU to re-evaluate the URSP rules and associate the traffic from the application with a different PDU Session. Two examples of events that may trigger URSP re-evaluation are an implementation dependent re-evaluation timer and the WTRU establishing access to a Wi-Fi network that provides internet access without using the 5G System (e.g., Non-Seamless Offload becomes possible).

A Traffic Descriptor may be an Application Descriptor, an IP descriptor, a Domain Descriptor, a non-IP descriptor, a DNN, or connection capabilities. An IP descriptor may be a Destination IP 3 tuple(s) (e.g., an IP address or IPv6 network prefix, port number, protocol ID of the protocol above IP).

The PCF may provide the WTRU with one or more WTRU policies. The PCF may provide each WTRU policy using one or more WTRU policy sections, each identified by a UPSI (UE Policy Selection Identifier).

URSP rules may be a type of WTRU policy.

VPLMN specific URSP rules may be provided. A VPLMN specific URSP rule may be applicable if the WTRU may be registered in the VPLMN and its equivalent PLMNs. VPLMN specific URSP rules may be provided from the HPLMN and may contain, based on agreements with a VPLMN, HPLMN values for Network Slice Selection Policies and DNN Selection Policies.

The PCF may provide the WTRU a mapping that that includes PLMN IDs and policy sections identifiers. The mapping table may indicate which policy sections (e.g., which URSP rules) should be applied, e.g., should only be applied, if the WTRU is registered in the identified PLMNs.

The mapping table may also be called a tuple. The policy sections may be identified with a UPSI.

If the WTRU may be registered in a PLMN where a PLMN specific URSP rule applies, the WTRU may evaluate the PLMN specific URSP rules over the URSP rules that may not be associated with a particular PLMN or the HPLMN.

If a WTRU does not support the information element that carries the mapping table, the WTRU may not support the VPLMN specific URSP rule feature. If the mapping table were to be sent to a non-supporting WTRU, the WTRU may ignore the mapping table and may still apply the URSP rules. However, the non-supporting WTRU may not know to prioritize the VPLMN specific URSP rules over other URSP rules and may therefore evaluate the rules in an order that may be different than that of a supporting WTRU.

Monitoring Enforcement of URSP rules may be provided. The PCF for the WTRU may subscribe to statistics for traffic monitoring of known traffic according to provisioned URSP rule(s). The PCF may configure this subscription in the NWDAF and the NWDAF may provide the statistics. If the PCF for a WTRU is notified that traffic which is not expected according to a URSP rule, the PCF for a WTRU may adjust the URSP rules because the unexpected application traffic was detected.

A PCF may determine if a WTRU supports the VPLMN specific URSP rules feature. The PCF may use this information to determine when to update a non-supporting WTRU with VPLMN specific URSP rules. By explaining how the PCF may determine the WTRU's support for the VPLMN specific rule feature, the PCF may properly configure the NWDAF to monitor how the WTRU applies URSP rules.

Configuration based on UR support of VPLMN specific URSP rules may be provided.

The WTRU may include, in the NAS Registration message, a vpimn-specific-ursp-support-indication that indicates the WTRU supports receiving VPLMN specific URSP rules. The vplmn-specific-ursp-support-indication may indicate that the WTRU understands the mapping table. This indication may be included in the 5GMM capability information element. The AMF may receive this indication and send it to the PCF that is selected by the AMF to serve the WTRU for AM Policy Association. The PCF that is selected by the AMF to serve the WTRU for AM Policy Association may be called the H-PCF.

The H-PCF may receive the vplmn-specific-ursp-support-indication from the AMF.

If the AMF indicates to the PCF that the WTRU does support the VPLMN specific URSP rule feature, then the PCF may determine to send the mapping table and VPLMN specific URSP rules to the WTRU. The mapping table and VPLMN specific URSP rules may be sent to the WTRU in the Registration Accept message or in a H-PCF initiated WTRU Configuration Update.

If the AMF indicates to the PCF that the WTRU does not support the VPLMN specific URSP rule feature or the AMF gives no indication that the WTRU does support VPLMN specific URSP rules, then the H-PCF may send no mapping table to the WTRU and may send the WTRU some URSP rules that are suitable to be applied, e.g., only suitable to be applied, when the WTRU is in the PLMN that the WTRU is currently registered in (e.g., a first PLMN). The PCF may also subscribe to the AMF to receive a notification if/when the WTRU's registered PLMN changes. If/when the PCF receives a notification that the PLMN from which the WTRU is registered has changed (e.g., the WTRU is not registered to a second PLMN), the PCF may choose to remove any URSP rules that are suitable to be applied, e.g., only suitable to be applied, if/when the WTRU is in the first PLMN and also send the WTRU URSP rules that are suitable to be applied, e.g., only suitable to be applied, when the WTRU is in the second PLMN. The PCF may update the rules by sending a WTRU Configuration Update.

The PCF may be made aware of whether or not the WTRU supports the VPLMN specific URSP rule feature and the PCF may, therefore, know what URSP rules will be applied by the WTRU, and the PCF may be able to properly configure the NWDAF to monitor how the WTRU applies URSP rules.

If the H-PCF receives service parameters from the V-PCF, the H-PCF may determine how to respond to the V-PCF based on the support indication that was received from the AMF. For example, if the WTRU does not support the feature, the H-PCF may respond to the V-PCF with an indication that the WTRU does not support the feature and that the service parameters may not be used to generate URSP rules for the WTRU. If the WTRU does not support the feature, the H-PCF may respond to the V-PCF with an indication that the WTRU does not support the feature, that the service parameters will be used to generate URSP rules for the WTRU, and that the WTRU may be sent, e.g., may only be sent, the URSP rules if the WTRU is registered in the VPLMN. If the WTRU does support the feature, the H-PCF may respond to the V-PCF with an indication that the WTRU does support the feature, that the service parameters may be used to generate URSP rules for the WTRU, and that the URSP rules may be sent to the WTRU immediately or the next time the WTRU is in the CM-CONNECTED state.

FIG. 3 depicts an example procedure for determining URSP support indication. As shown in FIG. 3, the H-PCF may determine if the WTRU supports the VPLMN specific URSP rule feature and determine when to deliver VPLMN specific URSP rules to the WTRU.

Referring to FIG. 3, at 1, a WTRU may send a Registration Request message to the AMF. The Registration Request message may include a vplmn-specific-ursp-support-indication.

At 2, the AMF may, e.g., may optionally, invoke a UDM (Unified Data Management) service to provide the UDM with an indication that the WTRU supports the VPLMN specific URSP rules feature. The UDM may store this indication in the WTRU's context in the UDR. The AMF may provide this indication when the AMF invokes the Nudm_UECM_Registration feature during the registration feature.

At 3, the AMF may select a PCF, e.g., H-PCF, to serve the WTRU for AM Policy Association (e.g., serve as the H-PCF). The AMF may consider the WTRU's support for the VPLMN specific URSP rule feature when selecting a PCF. For example, if the WTRU supports the feature, the AMF may determine to select an H-PCF that can receive VPLMN Service Parameters from V-PCF(s). The AMF may, e.g., may alternatively, provide a support indication when requesting that the NRF select a PCF to serve the WTRU. Once a H-PCF is selected, the AMF may perform an AM Policy Association Establishment or Modification procedure with the H-PCF and the AMF may provide the WTRU's support indication if/when the AMF invokes the Npcf_AMPolicyControl_Create service. The H-PCF may, e.g., may alternatively, be triggered to read the WTRU's context information in the UDR if/when the Npof_AMPolicyControl_Create service is invoked and may check if the WTRU's context indicates that the WTRU supports the VPLMN specific URSP rule feature.

At 4, the V-PCF may receive a request to configure one or more WTRUs with VPLMN specific URSP rules. The request may come from the V-UDR. The V-UDR may have been triggered to send the request by an AF. The V-UDR may send the service parameters to the V-PCF in a Nudr_DM_Notify message.

At 5, the V-PCF may send the Service Parameters to the H-PCF to request that the H-PCF use the Service Parameters to generate VPLMN specific rules for the WTRU. The V-PCF may send this information by invoking the H-PCF's Npcf_UEPolicyControl_Update request service operation.

At 6, the H-PCF may respond to the V-PCF with an indication of whether the Service Parameters may be used to generate VPLMN specific rules for the WTRU. The message from the H-PCF may indicate if the H-PCF may send the VPLMN specific URSP rules to the WTRU the next time that the WTRU is in CM-CONNECTED mode or when, e.g., only when, the WTRU is registered in the VPLMN. The response from the H-PCF may be sent in the Npcf_UEPolicyControl_Update response service operation.

At 7, if the H-PCF determined at 3 that the WTRU does not support the VPLMN specific URSP feature, the H-PCF may subscribe to the AMF to receive a notification if the WTRU registers in the PLMN or changes what PLMN it is registered to. The H-PCF may invoke the AMF's Namf_EventExposure service to configure this subscription.

At 8, the AMF may send a notification to the H-PCF to indicate to the H-PCF that the WTRU is registered in the VPLMN. The AMF may send this information to the H-PCF in an Namf_EventExposure_Notify service operation.

At 9, the PCF H-may send the VPLMN specific URSP rules to the WTRU. The rules may be sent to the WTRU in a WTRU Configuration Update Message. The H-PCF may include, e.g., may only include, the mapping table if the H-PCF previously received (at 3) an indication that the WTRU supports the feature. If the WTRU does not support the feature, the H-PCF may be triggered to send the VPLMN specific URSP rules when it receives a notification from the AMF that the WTRU is registered in the VPLMN. If the WTRU does support the feature, the H-PCF is triggered to send the VPLMN specific URSP rules after receiving the service parameters (at 5) and detecting that the WTRU is in connected mode. The WTRU may then apply the VPLMN specific URSP rules if new traffic is detected by the WTRU, if the WTRU changes PLMNs, or if new URSP rules are received.

After delivering the policies to the WTRU at 9, the H-PCF may send a notification (e.g., Npcf_EventExposure_Notify) that indicates that the policies were delivered to the WTRU and the notification may also indicate whether the WTRU indicated support for reception of VPLMN specific URSP rules. The indication may be used by the recipient to know if the service parameters from the VPLMN were used to generate VPLMN specific URSP rules for the WTRU or if the service parameters will be used to update the WTRU's URSP rules when the WTRU registers in the VPLMN. The recipient of the notification may be an AF (Application Function) or a V-PCF. The V-PCF may forward the notification to a V-AF. Including the indication of support of VPLMN specific URSP rules in this notification may be an alternative to indicating (at 6) whether the H-PCF will send the VPLMN specific URSP rules to the WTRU the next time the WTRU is in CM-CONNECTED mode or only when the WTRU is registered in the VPLMN.

Detecting WTRU Support of VPLMN specific URSP rules may be provided. In example implementations described in connection with FIG. 3, the WTRU may indicate that a support indication may be included in the 5GMM Capability information element.

The WTRU may send, e.g., may alternatively send, a UE STATE INDICATION message to the H-PCF. The UE STATE INDICATION may include an indication that the WTRU supports VPLMN specific URSP rules in the UE policy classmark IE.

The H-PCF may send, e.g., may alternatively send, the mapping table information element to the WTRU in a policy section. The policy section may be identified with a UPSI. The H-PCF may infer that the WTRU does not support VPLMN specific URSP rules until the WTRU sends a UE STATE INDICATION message to the H-PCF. The UE STATE INDICATION message may indicate that the UPSI that includes the mapping table may be stored in the WTRU.

Although features and elements are described herein in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-20. (canceled)

21. A network node comprising:
a processor configured to:
determine a wireless transmit and receive unit (WTRU) is not configured to support route selection policy rules;
receive a first message, the first message comprising service parameters associated with the WTRU, the service parameters applying if the WTRU is registered in a first visited public land mobile network (VPLMN) and the service parameters for use in generating route selection policy rules for the WTRU;
on a condition that the WTRU is not configured to support route selection policy rules, send a second message, the second message indicating that the route selection policy rules are to be sent to the WTRU if the WTRU becomes registered in the first VPLMN;
receive a third message from a network function;
generate route selection policy rules applicable to the WTRU while the WTRU is located in the first VPLMN; and
on a condition that the third message indicates the WTRU is registered in the first VPLMN, send a fourth message to the WTRU, the fourth message comprising the generated route selection policy rules for the WTRU while in the first VPLMN.

22. The network node of claim 21, further comprising computing memory, the computing memory having stored therein a policy control function (PCF).

23. The network node of claim 22, wherein the PCF is a home PCF (H-PCF).

24. The network node of claim 21, wherein the processor configured to receive the first message is further configured to receive the first message from a user data repository (UDR).

25. The network node of claim 21, wherein the processor configured to receive the first message is further configured to receive the first message from a PCF.

26. The network node of claim 21, wherein the processor configured to determine the WTRU is not configured to support route selection policy rules is further configured to receive a message indicating the WTRU is not configured to support route selection policy rules.

27. The network node of claim 26,
wherein the message indicating the WTRU is not configured to support route selection policy rules comprises an information element indicating the WTRU is not configured to support route selection policy rules.

28. The network node of claim 26, wherein the processor configured to receive the message indicating the WTRU is not configured to support route selection policy rules is further configured to receive the message indicating the WTRU is not configured to support route selection policy rules from an access and mobility management function (AMF).

29. The network node of claim 26, wherein the processor configured to receive the message indicating the WTRU is not configured to support route selection policy rules is further configured to receive the message indicating the WTRU is not configured to support route selection policy rules from a UDR.

30. The network node of claim 21, wherein the processor configured to receive the third message is configured to receive the third message from an AMF.

31. The network node of claim 30,
wherein the processor is further configured to send a request to the AMF to receive notification that the WTRU has become registered in the first VPLMN; and
wherein the third message indicates the WTRU has become registered in the first VPLMN.

32. A method comprising:
a computing system determining a wireless transmit and receive unit (WTRU) is not configured to support route selection policy rules;
the computing system receiving a first message, the first message comprising service parameters associated with the WTRU, the service parameters applying if the WTRU is registered in a first visited public land mobile network (VPLMN) and the service parameters for use in generating route selection policy rules for the WTRU;
the computing system, on a condition that the WTRU is not configured to support route selection policy rules, sending a second message, the second message indicating that the route selection policy rules are to be sent to the WTRU if the WTRU becomes registered in the first VPLMN;
the computing system receiving a third message from a network function;
the computing system generating route selection policy rules applicable to the WTRU while the WTRU is located in the first VPLMN; and
the computing system, on a condition that the third message indicates the WTRU is registered in the first VPLMN, sending a fourth message to the WTRU, the fourth message comprising the generated route selection policy rules for the WTRU while in the first VPLMN.

33. The method of claim 32, wherein the computing system comprises a policy control function (PCF).

34. The method of claim 32, wherein receiving the first message further comprises receiving the first message from a user data repository (UDR).

35. The method of claim 32, wherein receiving the first message further comprises receiving the first message from a PCF.

36. The method of claim 32, wherein determining the WTRU is not configured to support route selection policy rules further comprises receiving a message indicating the WTRU is not configured to support route selection policy rules.

37. The method of claim 36,
wherein the message indicating the WTRU is not configured to support route selection policy rules comprises an information element indicating the WTRU is not configured to support route selection policy rules.

38. The method of claim 36, wherein receiving the message indicating the WTRU is not configured to support route selection policy rules further comprises receiving the message indicating the WTRU is not configured to support route selection policy rules from one of an access and mobility management function (AMF) or UDR.

39. The method of claim 32, further comprising
sending a request to an AMF to receive notification that the WTRU has become registered in the first VPLMN;
wherein receiving the third message further comprises receiving the third message from the AMF; and
wherein the third message indicates the WTRU has become registered in the first VPLMN.

40. A network node comprising:
a processor configured to:
receive a first message, the first message comprising service parameters associated with a wireless transmit and receive unit (WTRU), the service parameters applying if the WTRU is registered in a first visited public land mobile network (VPLMN) and the service parameters for use in generating route selection policy rules for the WTRU;
on a condition that the WTRU is not configured to support route selection policy rules, send a second message, the second message indicating that the route selection policy rules are to be sent to the WTRU if the WTRU becomes registered in the first VPLMN;
generate route selection policy rules applicable to the WTRU while the WTRU is located in the first VPLMN; and
on a condition that the WTRU becomes registered in the first VPLMN, send a third message to the WTRU, the third message comprising the generated route selection policy rules for the WTRU while in the first VPLMN.
